(19) United States
(12) Patent Application Publication
(10) Pub. No.: US 2013/0097271 A1
(43) Pub. Date: Apr. 18, 2013

(54) METHOD, TERMINAL AND SERVER FOR DISPLAYING TEXT IN INSTANT MESSAGING SYSTEMS

(71) Applicant: TENCENT TECHNOLOGY (SHENZHEN) COMPA, Shenzhen (CN)

(72) Inventor: JIAN HE, Shenzhen (CN)

(73) Assignee: TENCENT TECHNOLOGY (SHENZHEN) COMPANY LIMITED, Shenzhen (CN)

(21) Appl. No.: 13/709,173

(22) Filed: Dec. 10, 2012

Related U.S. Application Data
(63) Continuation of application No. PCT/CN2011/072208, filed on Mar. 28, 2011.

(30) Foreign Application Priority Data
Jun. 10, 2010 (CN) 2010101971902

(51) Int. Cl. H04L 12/58

(52) U.S. Cl. CPC H04L 51/04
USPC 709/206

(57) ABSTRACT

The embodiments of the present invention disclose a method for displaying texts in an instant messaging system. The method includes: obtaining the preconfigured text display format information while logging in the instant messaging system; displaying the received message sent from the instant message sender terminal using the preconfigured text display format. The embodiments of the present invention also disclose an electronic terminal, a server, or a communication system. The embodiments of the present invention can be implemented to achieve the automatic display of the received instant message according to the user's desired format, solving the problem of the current technologies that the text message display cannot meet user's individual needs, avoiding resetting the text display format for each chat, enhancing the performance of real-time instant messaging system, helping the user to use instant messaging systems more conveniently and improving the user experiences.

### CROSS-REFERENCES TO RELATED APPLICATIONS

The present invention is a continuation of PCT application no. PCT/CN2011/072208, filed on Mar. 28, 2011, which claims the Chinese patent application no. 2010101971902, filed on Jun. 10, 2010, the contents of all of which are incorporated herein by reference.

### TECHNICAL FIELD

The present invention relates to the field of communication and, more particularly, to instant messaging text display methods, electronic terminals, servers, and systems used in the instant messaging systems.

### BACKGROUND

In today's information society, there is a growing emphasis on the timeliness of information exchange and communication. Correspondingly, there is an increasing requirement for the timeliness of information transmission. Therefore, instant messaging (IM) technology has become more and more widely-used to allow people to communicate with each other more conveniently.

Internet instant messaging is a near real-time messaging service over the Internet. In a dialog window of current instant messaging systems, when a text message sent by an instant messaging sender (a sender terminal) is displayed on the screen at a receiver terminal, the text display format is usually the default settings of the instant messaging system or set by the sender terminal. This type of text display format usually cannot meet the users' individual needs. For example, if an elderly would like to see the text with a relatively large font size, the instant messaging receiver terminal needs to remind the sender to reset the font style and size. After the chat session is completed, the sender still needs to reset the text font back to his/her own favorite text format. Therefore, this is not convenient for the instant message sender and receiver to conduct the real-time communication and can lead to poor user experience.

### SUMMARY OF THE INVENTION

Embodiments of the present invention provide a text display method, electronic terminal, server and system of an instant messaging system. The text display method, the electronic terminal, server, and system can be utilized to automatically display the text message according to a user-preferred format, which may improve the user experiences in the instant messaging communication.

In certain embodiments, a text display method is provided in an instant messaging system having a receiver terminal and a sender terminal The method includes the receiver terminal obtaining preconfigured text display format information when logging into the instant messaging system before receiving text messages from the sender terminal;

and the receiver terminal displaying received text messages sent by the sender terminal according to the obtained preconfigured text display format information.

In certain other embodiments, an electronic terminal is provided for communicating with a sender terminal in an instant messaging system. The electronic terminal includes a login module configured to log into the instant messaging system; an obtaining module configured to obtain preconfigured text display format information when the login module logs into the instant messaging system; a receiving module configured to receive the text message content sent from a sender terminal; and a display module configured to display the text message content received by the receiving module according to the preconfigured text display format.

In certain other embodiments, a server is provided in an instant messaging system having a receiver terminal. The server includes a text display format receiving module configured to receive text display format information sent by the receiver terminal; and a storage module configured to save the text display format information received by the text display format receiving module.

The embodiments of the present invention have the following beneficial effects: by obtaining the preconfigured text display format information by logging in the instant messaging system and displaying the received message using the preconfigured text display format to achieve the automatic display of the received instant message according to the user's desired format, to solve the problem of the current technologies that the text message display cannot meet user's individual needs, to avoid resetting the text display format for each chat, to enhance the performance of real-time instant messaging system, to help the user to use instant messaging systems more conveniently, and to improve the user experiences.

### BRIEF DESCRIPTION OF THE DRAWINGS

In order to more clearly depict the technical solutions in the embodiments of the present invention or existing technologies, the accompanying drawings illustrating the embodiments or the existing technologies are introduced briefly below. Obviously, the accompanying drawings described hereinafter are only some of the embodiments of the present invention, and those skilled in the art can derive other drawings upon examination of such accompanying drawings without any creative effort.

FIG. 1 is a flowchart illustrating a method used in the first embodiment for text display in the instant messaging system of the present invention;

FIG. 2 is a flowchart illustrating a method used in the second embodiment for text display in the instant messaging system of the present invention;

FIG. 3 is a flowchart illustrating a method used in the third embodiment for text display in the instant messaging system of the present invention;

FIG. 4 shows a schematic block diagram of an instant messaging system in the embodiments of the present invention;

FIG. 5 shows a schematic block diagram of an electronic terminal in the first embodiment of the present invention;

FIG. 6 shows a schematic block diagram of an obtaining module in embodiments of the present invention;

FIG. 7 shows a schematic block diagram of an electronic terminal in the second embodiment of the present invention;

FIG. 8 shows a schematic block diagram of the server in the first embodiment of the present invention;

FIG. 9 shows a schematic block diagram of the server in the second embodiment of the present invention.

### DETAILED DESCRIPTION

The technical solutions in the embodiments of the present invention are described below with references to accompanying drawings. Obviously, the embodiments described below are only some embodiments of the present invention, and do not include all embodiments of the present invention. All other embodiments that can be derived by those skilled in the art from the embodiments herein, without any creative effort, are included in the protection scope of the present disclosure.

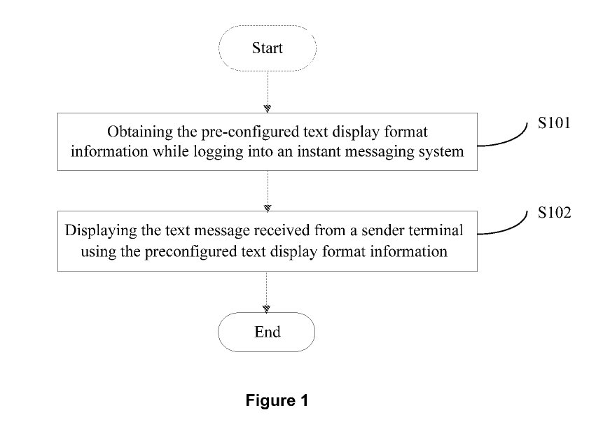

FIG. 1 is a flowchart illustrating a method used in the first embodiment for text display in the instant messaging system of the present invention. As shown in FIG. 1, the method includes:

Step S101: obtaining the preconfigured text display format information when logging into an instant messaging system. Specifically, after a user uses an electronic terminal to log into an instant messaging system (e.g., Tencent QQ, Tencent Messenger (TM), or Microsoft Network services (MSN), etc.), the electronic terminal will automatically connect to a server to obtain the preconfigured text display format information, which is the text display format preconfigured by the user based on the user's own needs.

Step S102: displaying the text messages received from a sender terminal according to the preconfigured text format information. Specifically, after the user logs into the instant messaging system to communicate with other users, the electronic terminal receives the text messages sent by the sender terminal and displays them according to the obtained preconfigured text display format.

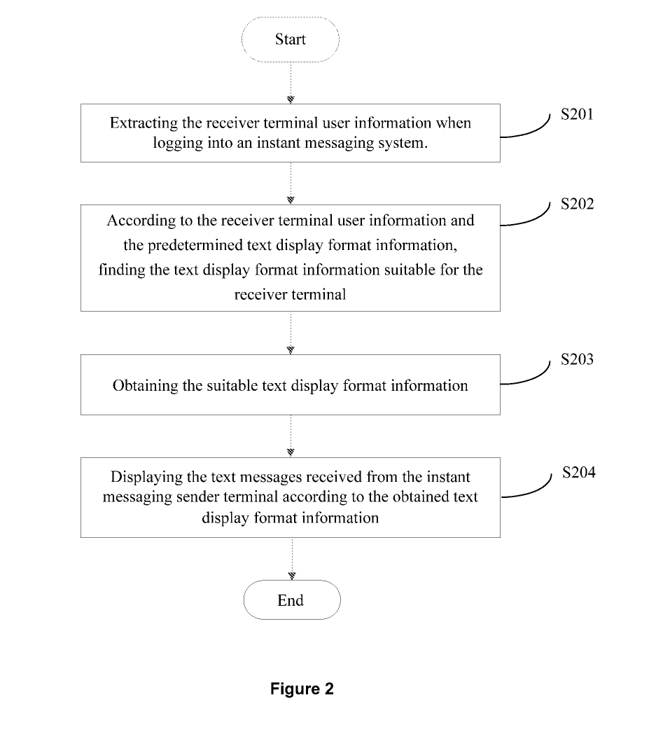

FIG. 2 is a flowchart illustrating the method used in the second embodiment for text display in the instant messaging system of the present invention. As shown in FIG. 2, the method includes:

Step S201: extracting the receiver terminal user information when the user/receiver terminal logs into an instant messaging system. Specifically, the receiver terminal user information may include the user information recorded by the instant messaging system, such as the user's age information, or the message contents communicated between the receiver terminal and sender terminal

Step S202: searching and finding the text display format information suitable for the receiver terminal according to the receiver terminal user information and the preconfigured text display format information.

Specifically, if the receiver terminal user information is the receiver terminal user's age information, the receiver terminal may be preconfigured with the text display format information corresponding to the age information. That is, the receiver terminal may be preconfigured with different text display format information which corresponds to different age groups (e.g., one text display format can be configured for users aged between 18-20, and another text display format can be configured for users aged between 21-23, etc.). During an instant messaging session, the receiver terminal searches and finds the corresponding preconfigured text display format information according to the age information of the receiver terminal user, i.e., to find the text display format information suitable for the receiver terminal

If the receiver terminal user information is the message content communicated between the receiver terminal and the sender terminal, the receiver terminal may be preconfigured with the text display format information corresponding to the message content. That is, the receiver terminal may be preconfigured with different text display format information which corresponds to certain commonly-used words or phrases in the message content (e.g., communication words such as BT (means perverted) or FB (means corruption) correspond to the text formats suitable for users aged between 21 and 23, the communication words or phrases such as “ [symbol] ” (means embarrassing) or “buying soy sauce” (means passing-by) correspond to the text formats suitable for users aged between 24-26, etc.). During the instant messaging session, based on the message content information, the receiver terminal identifies whether there is corresponding preconfigured text display format information. If such text display format information does exist, the receiver terminal searches and finds the corresponding preconfigured text format information. In other words, if the message content between the receiver and the sender obtained by the receiver terminal is “buying soy sauce,” and there exists a corresponding preconfigured text display format, and the receiver terminal finds the preconfigured text display format information suitable for users aged between 24-26.

Step S203: obtaining the text display format information found by the receiver terminal

Step S204: displaying the text messages received from the instant messaging sender terminal according to the obtained text display format information.

Specifically, the text display format information may include text display formats or effects, such as font size, font style, line spacing, and color, etc. The electronic terminal can be preconfigured with different text display format information according to the user's needs, such as pre-configuring different text display format information corresponding to different age groups. After the electronic terminal (receiver terminal) finds or obtains the suitable text display format information, the electronic terminal displays the message content received from the instant messaging sender terminal using the suitable text display format information, such as displaying the content using the suitable text display formats or effects, such as displaying font size, font style, line spacing color, or text effects, etc.

It should be noted that, the text display method used in the instant messaging systems in the embodiments of the present invention is not limited to pre-configuring different text display format information corresponding to different age groups, as long as the different text display format information is pre-configured according to the user's individual needs.

Further, the electronic terminal can send the pre-configured text display format information to a server for storage, or save the pre-configured text display format information on the receiver terminal That is, the server or the electronic terminal has memory to store the pre-configured text display format information. Further, the electronic terminal can modify the text display format information and send the modified text display format information to the server for storage, or save the modified text display format information on the receiver terminal

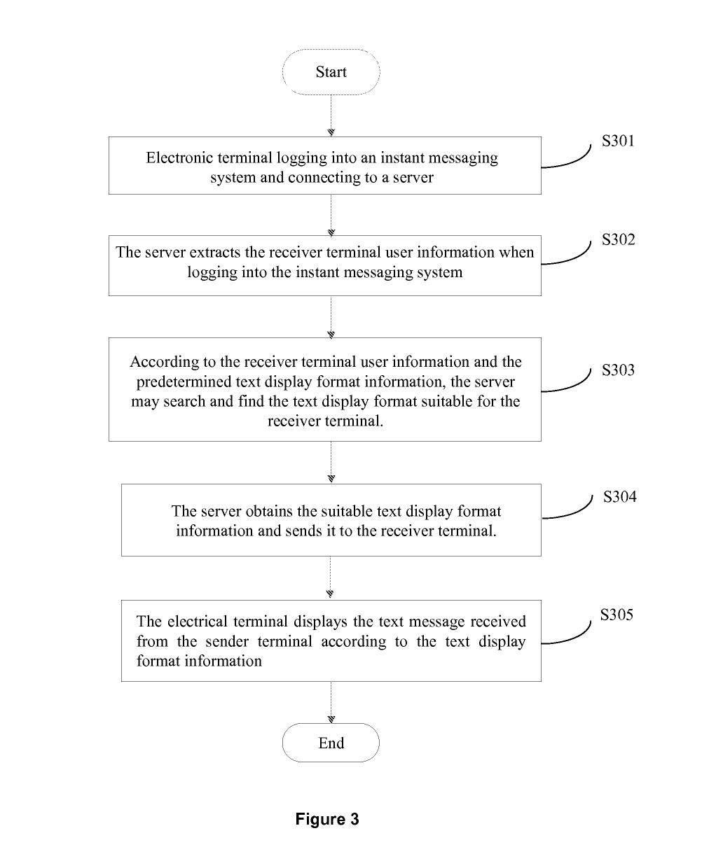

An example is given below to describe the steps in which the receiver terminal sends the pre-configured text display format information to the server for storage. FIG. 3 is a flowchart illustrating the method used in the third embodiment of the present invention for text display in the instant messaging systems of the present invention. As shown in FIG. 3, the method includes:

Step S301: the electronic terminal logs into the instant messaging system and connects to the server. Specifically, the user logs into the instant messaging system via the electronic terminal and connects the corresponding server.

Step S302: the server obtains the receiver terminal user information of the receiver terminal when logging into the instant messaging system. Specifically, after the electronic terminal logs into the instant messaging system, the server extracts the receiver terminal user information of the receiver terminal for logging into the instant messaging system (i.e. the user information on the electronic terminal).

Step S303: according to the receiver terminal user information and the pre-configured text display format information, the server may search and acquire the text display format suitable for the receiver terminal The receiver terminal user information can be the user's age information recorded by the instant messaging system, or the message content communicated between the instant messaging receiver terminal and sender terminal

Step S304: the server obtains the acquired text display format information and sends the text display format information to the receiver terminal Specifically, similar to Step S202, the server obtains the acquired text display format information and sends the text display format information to the receiver terminal (the electronic terminal). The details are omitted herein.

Step S305: the receiver terminal displays the text message received from the sender terminal according to the text display format information.

It should be noted that, after receiving text display format information sent by the electric terminal, the server saves the text display format information. Specifically, the server saves the identification information of the electric terminal corresponding to the text display format information. The identification information of the electric terminal includes, but not limited to, the user's login account information, name information, etc., as long as the identification information of the electric terminal and the saved text display format information are in one-to-one correspondence.

If the identification information of an electric terminal has already been in existence on the server, the server may determine that the user needs to modify the saved text display format information. The server may delete the previously-saved text display format information corresponding to the present identification information of the receiver terminal and save the newly received text display format information. That is, the server saves the newest text display format information configured by the user.

Further, it should be noted that electronic terminal also sends its own identification information while sending the corresponding preconfigured text display format information to the server.

The followings are detailed descriptions, using as an example, about a user logging into instant messaging system QQ:

1. Text display format information is saved at the receiver terminal (i.e., electronic terminal): after user A logs into QQ via the receiver terminal, QQ automatically obtains the user information of user A, for example, the age information corresponding to the account of user A. For example, if the obtained user age is 22, QQ may acquire the preconfigured and saved text display format information corresponding to the age of 22 (such as Arial, 11-point font, blue color, etc.) and display the instant message received from the sender terminal using Arial, 11-point font, and blue color, etc., as the text display format. Or after user A logs into QQ and chats with a user at a sender terminal, QQ automatically extracts the chat content and identify whether there is a preconfigured text display format corresponding to such content. If there is such preconfigured text display format information (such as Times New Roman, 12-point font, red color, etc.), then the instant message that the user A receives from the sender terminal can be displayed in the text display format of Times New Roman, 12-point font, red color, etc.

2. The text display format information is saved in the instant messaging server: after user A logs into QQ, QQ sever automatically obtains user A's user information, such as the age information corresponding to the account number of user A. For example, if the obtained user age is 22, QQ server will acquire the preconfigured and saved text display format information corresponding to the age of 22 (such as Arial, 11-point font, blue color, etc.), and send such text display format information to user A. The message content received by user A from the sender terminal is displayed using text display format of Arial, 11-point font, blue color, etc. Or after user A logs into QQ and chats with a user at the sender terminal, QQ server automatically extracts the chat content and identify if there exists a preconfigured text format corresponding to such content. If such preconfigured text display format information (such as Times New Roman, 12-point font, red color, etc.) does exist, the server may send this text display format information to user A. The instant messages received by user A from the sender terminal will be displayed according to the obtained text display format of Times New Roman, 12-point font, red color, etc.

Further, the text display method in the present invention is also applicable for user A chatting in a QQ group. The message content that user A receives from other participants in the QQ group can be displayed according to the obtained text display format described above.

The text message display method in the embodiments of the present invention is illustrated above. The followings illustrate details of the communication/messaging system in the embodiments of the present invention.

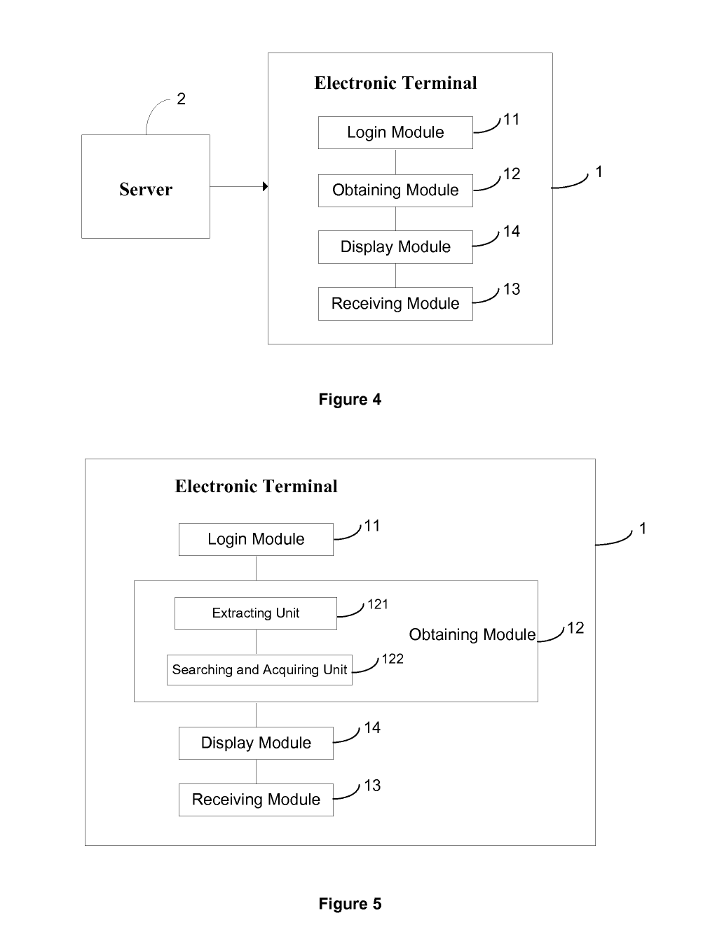

FIG. 4 shows a block diagram of an instant messaging system in the embodiments of the present invention. As shown in FIG. 4, the instant messaging system includes electronic terminal 1 and the server 2 connected to the electronic terminal 1, wherein the electronic terminal 1 includes login module 11, obtaining module 12, receiving module 13 and display module 14, where the login module 11 is configured to log into the instant messaging system; and the obtaining module 12 is configured to obtain the preconfigured text display format information when the login module 11 logs into the instant messaging system.

Specifically, after the user, via electronic terminal 1, logs into the instant messaging system (including Tencent QQ, Tencent Messenger (TM), or Microsoft Network services (MSN), etc.), the electronic terminal 1 automatically connects to the server 2 and obtains the preconfigured text display format information via obtaining module 12. The text format is preconfigured by the user according to the user's individual needs.

The receiving module 13 is configured to receive text messages sent by the sender terminal Specifically, the user communicates with other users by logging into the instant messaging system. The receiving module 13 in electronic terminal 1 receives the text messages sent by the sender terminals (other electronic terminals).

The display module 14 is configured to display the text message received by the receiving module 13 based on the preconfigured text display format. Specifically, the text display format information includes display formats or effects such as text size, font style, line spacing, and color, etc. The display module 14 displays the received message from other sender terminals according to the text display format information acquired by the obtaining module 12, such as text size, font style, line spacing, and color, etc.

FIG. 5 shows a block diagram of an electronic terminal in the first embodiment of the present invention. As shown in FIG. 5, the electronic terminal 1 includes login module 11, obtaining module 12, receiving module 13 and display module 14. The obtaining module 12 further includes extracting unit 121, and searching and acquiring unit 122.

Extracting unit 121 is configured to extract the receiver terminal user information for the receiver terminal logging into the instant messaging system. Specifically, the receiver terminal user information may include the information recorded by the instant messaging system such as the age information of the user at the receiver terminal, and the message content communicated between the receiver terminal and the sender terminal, etc.

Searching and acquiring unit 122 is configured to search the text display format information suitable for the receiver terminal and to obtain such suitable text display format information, based on the receiver terminal user information and the preconfigured text display format information extracted by the extracting unit 121,

Specifically, if the receiver terminal user information is the user's age information recorded by the instant messaging system, the electronic terminal 1 may pre-configure the text display format information corresponding to the user age information. That is, the electronic terminal 1 may be preconfigured with different text display format information which corresponds to different age groups (e.g., one text display format can be set for users aged between 18-20, and another text display format can be set for users aged between 21-23, etc.). The searching and acquiring unit 122 searches and finds the relevant preconfigured text display format information according to the age information of the receiver user, i.e., to find the text display format information suitable for the receiver terminal

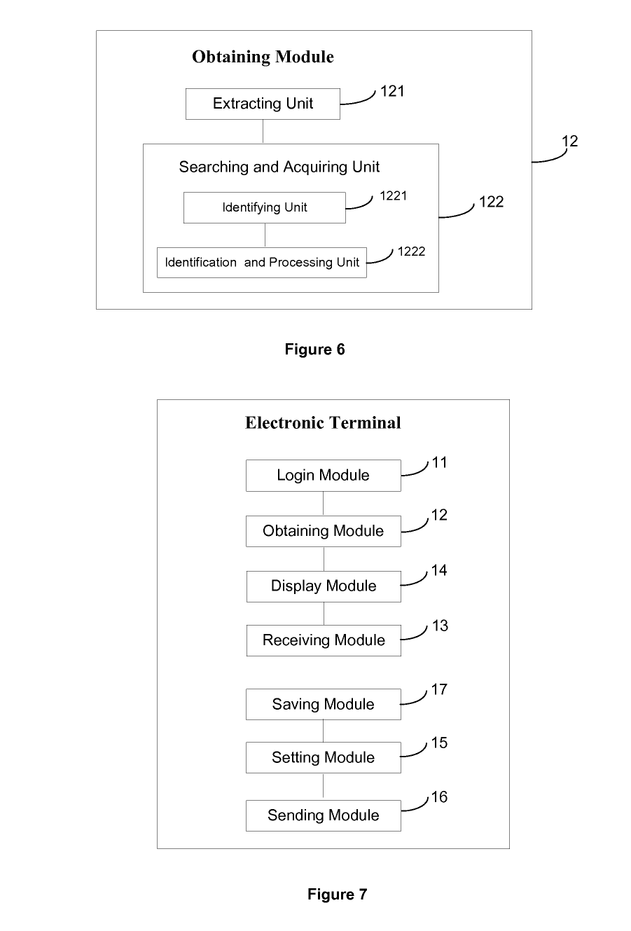

Further, FIG. 6 shows a block diagram of obtaining module in embodiments of the present invention. As shown in FIG. 6, obtaining module 12 includes extracting unit 121 and searching and acquiring unit 122. The searching and acquiring module unit 122 includes identifying unit 1221 and identification processing unit 1222.

The identifying unit 1221 is configured to identify whether there is corresponding preconfigured text display format information according to the message content identification information. The identification processing unit 1222 is configured to search and find the corresponding preconfigured text display format information if the identifying unit 1221 determines such text display format information does exists.

Specifically, if the receiver terminal user information is the message content communicated between the receiver terminal and the sender terminal, the electronic terminal 1 may be preconfigured with the text display format information corresponding to the message content. That is, the electronic terminal 1 may be preconfigured with different text display format information which corresponds to certain commonly-used words or phrases in the message content (e.g., communication words such as BT or FB correspond to the text formats suitable for users aged between 21 and 23, the communication words or phrases such as “ [symbol] ” (means embarrassing) or “buying soy sauce” correspond to the text formats suitable for users aged between 24-26, etc.). The identifying unit 1221 identifies if there exists corresponding predetermined text display format information. If there is, i.e., the identifying unit 1221 determines that such text display format information does exist, the identification processing unit 1222 searches and finds the preconfigured text display format information. For example, the extracting unit 121 extracts “buying soy sauce” in the message contents between the receiver terminal and the sender terminal and the information identifying unit1221 identifies a corresponding preconfigured text display format information, then the identification processing unit 1222 searches and finds the text display format information suitable for users aged between 24 and 26, and obtain the searched text display format information.

FIG. 7 shows a block diagram of an electronic terminal in the second embodiment of the present invention. As shown in FIG. 7, the electronic terminal 1 includes login module 11, obtaining module 12, receiving module 13 and display module 14. The electronic terminal 1 further includes setting module 15, sending modules 16, and/or saving module 17. The embodiment of the invention is described using an example including both sending module 16 and saving module 17.

Setting module 15 is used to configure the text display format information. Specifically, the text display format information includes display formats or effects, such as display text size, font, line spacing, and color, etc. Setting module 15 can set or configure different text display format information corresponding to different age groups. For example, one text display format information is set for users aged between 18 and 20 and another text display format information is set for users aged between 21 and 23. Setting module 15 can also configure different text display format information corresponding to some commonly used words or phrases in instant messages. For example, the message contents such as BT or FB correspond to the text format suitable for users aged between 21 and 23. The message contents such as “ [symbol] ” (means embarrassing) or “buying soy sauce” correspond to the text formats suitable for users aged between 24 and 26. It should be noted that, the setting module 15 in the embodiments of the present invention is not limited to setting different text formats according to the different age groups, as long as the different text formats are set according to the user's own needs.

Sending module 16 is configured to send the text display format information set by the setting module 15 to the server for storage. Saving module 17 is configured to save the text display format information configured by setting module 15 at the receiver terminal

Further, the electronic terminal 1 may also include a modifying module (not shown) for modifying the text format information. Sending module 16 sends the modified text display format information to the server for storage, or saving module 17 saves the modified text display format information on the receiver terminal

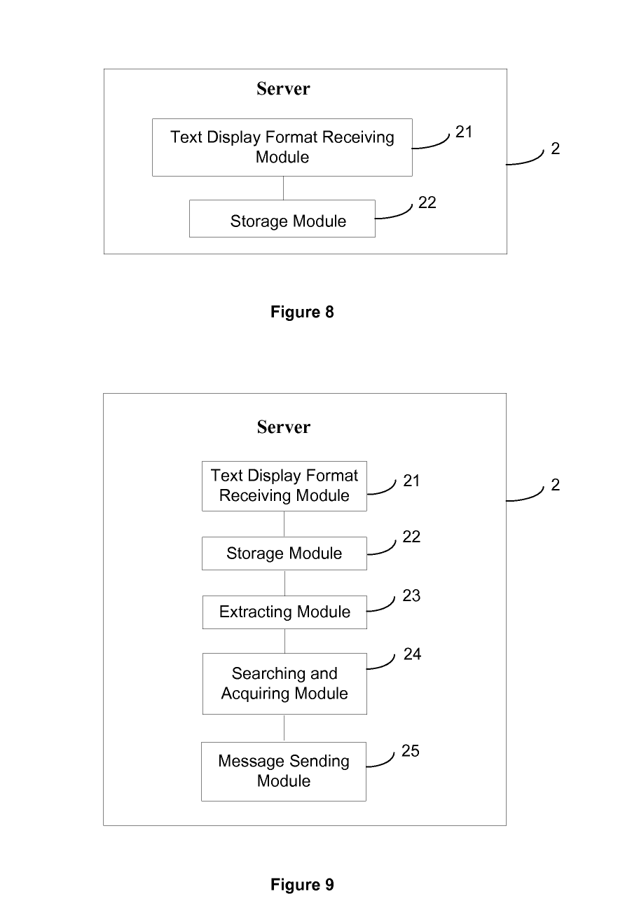

FIG. 8 shows a block diagram of the server in the first embodiment of the present invention. As shown in FIG. 8, the server 2 includes a text display format receiving module 21 and storage module 22. Text display format receiving module 21 is configured to receive the text display format information sent by the electronic terminal 1. Storage module 22 is configured to store the text display format information received by the text display format receiving module 21.

FIG. 9 shows a block diagram of the server in the second embodiment of the present invention. As shown in FIG. 9, in addition to the text display format receiving module 21 and storage module 22, server 2 also includes extracting module 23, searching and acquiring module 24, and the message sending module 25, where the extracting module 23 is configured to extract the information of the user at the electronic terminal in the instant messaging system;

The searching and obtaining module 24 is configured to search the text display format information suitable for the user at the receiver terminal and obtain such text display format information, based on the receiver terminal user information and the preconfigured text display format information extracted by the extracting module 23.

The message sending module 25 is configured to send the text display format formation acquired by searching and acquiring module 24 to the electronic terminal

It should be noted that the electronic terminal 1 of the instant messaging system in the embodiments of the present invention can obtain the preconfigured text display format information from the receiver terminal or from the server 2. The followings describe the details using as an example of the terminal 1 obtaining the preconfigured text display format information from the server 2.

When the user logs in to the instant messaging system via the electronic terminal 1, the electronic terminal 1 connects to the corresponding server 2. After the server 2 detects that the electronic terminal has logged in the instant messaging system, the extracting module 23 extracts the receiver terminal user information (the user information of electronic terminal 1) in the instant messaging system. According to the user information of the electronic terminal 1 and the preconfigured text format information, the searching and acquiring module 24 searches and finds the text display format information suitable for the receiver terminal from the storage module 22. The receiver terminal user information may include the age information of the user at the receiver terminal, or the message content communicated between the receiver terminal and the sender terminal. The information sending module 25 sends the text display format information to the electronic terminal 1 and the electronic terminal 1 then displays the text message received from the sender terminal according to the text display format information.

It should be noted, after the server 2 receives the text display format information sent by the receiver terminal (electronic terminal 1), the storage module 22 stores the text display format information. Specifically, the storage module 22 stores the identification information of the message sending terminal which corresponds to the text display format information. The identification information of the message sending terminal includes, but not limited to, the user's login account information, name information, as long as the identification information of the messaging sending terminal corresponds to the text display format information. When the identification information of the message sending terminal corresponding to the text display format information already exists, the server 2 decides that the user currently needs to modify the saved text display format information. The server 2 will delete the saved text display format information corresponding to the identification formation of the sender terminal and save the received text display format information, that is, the server 2 saves the newest text display format information set by the user.

It is also noted that, when the electronic terminal 1 sends the text display format information to the server 2, the electronic terminal 1 also sends its own identification information to server 2.

Thus, the embodiments in the present invention show that the preconfigured text display format is obtained while the user logs into the instant messaging system and the received messages can be displayed according to the preconfigured text display format information. This invention implements an automatic display of the received text message according to the user's desired text format and solves the problems existed in the current technologies that the users' individual needs cannot be met, thus avoiding the re-setting text display format for each chat, enhancing the performance of real-time communication system, and making the user using instant messaging systems more conveniently and improving the quality of user experiences.

Those skilled in the art can understand that whole or parts of the process in the above-described embodiments can be implemented by controlling relevant hardware using computer programs. The computer programs can be stored in computer-readable storage media. During the program execution, the program may carry out the processes described in the embodiments. Further, the storage medium can be a magnetic disk, optical disk, read-only storage memory (ROM), or random access memory (RAM), etc.

The above disclosure only provides certain preferred embodiments of the present invention and certainly cannot be used to limit the scope of the present invention.

Therefore, any equivalent changes in the light of claims in the present invention still fall under the scope of the protection of the present invention.

What is claimed is:

1. A text display method used in an instant messaging system having a receiver terminal and a sender terminal, the method comprising:
obtaining, by the receiver terminal, preconfigured text display format information when logging into the instant messaging system before receiving text messages from the sender terminal; and
displaying, by the receiver terminal, received text messages sent by the sender terminal according to the obtained preconfigured text display format information.

2. The method according to claim 1, wherein the obtaining the preconfigured text display format information further includes:
extracting, by the receiver terminal, receiver terminal user information when the receiver terminal is logging into the instant messaging system;
searching, by the receiver terminal, text display format information suitable for the receiver terminal based on the receiver terminal user information and the preconfigured text display format information; and
retrieving the suitable text display format information.

3. The method according to claim 2, wherein the receiver terminal user information includes message content communicated between the receiver terminal and the sender terminal, and the searching text display format information suitable for the receiver terminal based on the receiver terminal user information and the preconfigured text display format information further includes:
identifying whether there is preconfigured text display format information corresponding to the message content; and
when there is, searching the corresponding preconfigured text display format information.

4. The method according to claim 1, wherein the instant messaging system further comprises a server, and before obtaining the preconfigured text display format information, the method further including:
configuring, by the receiver terminal, the text display format information; and
sending, by the receiver terminal, the configured text display information to the server for storage, or saving the configured text display information on the receiver terminal

5. The method according to claim 4, after sending the configured text display information to the server for storage or saving the configured text display information on the receiver terminal, further including:
modifying, by the receiver terminal, the text display format information; and
sending, by the receiver terminal, the modified text display format information to the server for storage, or saving the modified text display format information on the receiver terminal

6. The method according to claim 4, wherein, when sending the configured text display information to the server for storage, the obtaining the preconfigured text display format information further includes:
extracting, by the server, the receiver terminal user information when the receiver terminal is logging into the instant messaging system;
searching, by the server, text display format information suitable for the receiver terminal based on the receiver terminal user information and the preconfigured text display format information;
obtaining, by the server, the suitable text display format information; and
sending, by the server, the suitable text display format information to the receiver terminal

7. An electronic terminal for communicating with a sender terminal in an instant messaging system, the electronic terminal comprising:
a login module configured to log into the instant messaging system;
an obtaining module configured to obtain preconfigured text display format information when the login module logs into the instant messaging system;
a receiving module configured to receive the text message content sent from a sender terminal; and
a display module configured to display the text message content received by the receiving module according to the preconfigured text display format.

8. The electronic terminal according to claim 7, wherein the obtaining module further includes:
an extracting unit configured to extract receiver terminal user information when logging into the instant messaging system; and
a searching and acquiring unit configured to search text display format information suitable for the receiver terminal based on the receiver terminal user information and the preconfigured text display format information, and to obtain the suitable text display format information.

9. The electronic terminal according to claim 8, wherein the receiver terminal user information includes message content communicated between the receiver terminal and the sender terminal, and the searching and acquiring unit further includes:
an identifying unit configured to identify whether there is preconfigured text display format information corresponding to the message content; and
an identification processing unit configured to, when there is preconfigured text display format information corresponding to the message content, search and obtain the corresponding preconfigured text display format.

10. The electronic terminal according to claim 7, further including:
a setting module configured to configure the text display format information; and
at least one of a sending module and a saving module, wherein the sending module is configured to send the configured text display format information to a server in the instant messaging system for storage; and
the saving module is configured to save the configured text display format information on the receiver terminal

11. The electronic terminal according to claim 10, further including:
a modifying module configured to modify the text format information,
wherein the sending module is configured to send the modified text display format information to the server for storage, or the saving module is configured to save the modified text display format information on the receiver terminal.

12. A server used in an instant messaging system having a receiver terminal, the server comprising:
a text display format receiving module configured to receive text display format information sent by the receiver terminal; and
a storage module configured to save the text display format information received by the text display format receiving module.

13. The server according to claim 12, further including:
an extracting module configured to extract electronic terminal user information when the receiver terminal logs in the instant messaging system;
a searching and acquiring module configured to search and find text display format information suitable for the receiver terminal according to the electronic terminal user information extracted by the extracting module and preconfigured text display format information, and to obtain the suitable text display format information; and
an information sending module configured to send the text display format information obtained by the searching and acquiring module to the electronic terminal

14. The server according to claim 12, wherein the text display format information is obtained by the receiver terminal before receiving text messages from a sender terminal in the instant messaging system; and
the text display format information is used by the receiver terminal to display received text messages sent by the sender terminal
